(19) United States
(12) Patent Application Publication
(10) Pub. No.: US 2009/0305689 A1
(43) Pub. Date: Dec. 10, 2009

(54) LOAD REDUCTION IN WIRELESS COMMUNICATION TOWERS

(75) Inventor: Peruvemba Natarajan, Randolph, NJ (US)

Correspondence Address: Adorno & Yoss, LLC, 1349 West Peachtree Street, NE, Suite 1500, Atlanta, GA, 30309, US

(73) Assignee: Nsoro, Inc., Atlanta, GA (US)

(21) Appl. No.: 12/259,394

(22) Filed: Oct. 28, 2008

Related U.S. Application Data
(60) Provisional application No. 61/060,184, filed on Jun. 10, 2008.

(51) Int. Cl. H04W 4/00; H04M 1/00

(52) U.S. Cl. 455/422.1; 455/562.1

(57) ABSTRACT

Metal-based (coaxial) cables traditionally found on communication towers, which are a significant part of payload weight on the tower, are reduced/eliminated by using optical communication between an on-ground electronics box and an on-tower electronics box through a fiber line. Payload weight and cabling cost may be significantly reduced simplifying tower design process. Reliability may also be increased through reduced failure rate (fewer cables) and optical communication. The use of fiber-optic feed lines reduces the wind load on the tower and allows the tower to be smaller in size and to be built at less cost. A smaller size tower also reduces the negative impact on the aesthetic appeal of the surrounding area.

### RELATED APPLICATIONS

This application claims priority from U.S. Provisional Application Ser. No. 61/060,184, filed on Jun. 10, 2008, disclosure of which is hereby incorporated by reference for all purposes.

### BACKGROUND

With evolution and proliferation of wireless transmission technologies equipment for multiple mobile operators are increasingly co-located on the same tower. Depending on an operator's technology, even a site hosting just a single mobile operator may house multiple base stations, each serving a different air interface technology (e.g. CDMA, GSM, and the like). Furthermore, local regulations in certain areas may require multiple operators to co-locate on the same tower to minimize the proliferation of towers.

Cell towers may include connections via copper facilities, optical fiber, or microwave. Copper facilities deliver either T1 or E1 type data communications, while microwave and optical fiber can offer T3 or Ethernet in addition to T1s or E1s. Copper facilities and optical fiber may be provided as part of a service from the telephone company, while microwave may be generally self-built by the mobile communication company. A mobile network typically also includes Base Station Controllers (BSCs) and Radio Network Controllers (RNCs) at the mobile telephone switching office (MTSO). The base station controller may be connected to a telephone switch, which in turn may be connected to the public switched telephone network (PSTN). The Radio Network Controller may handle 3 G service connected to a Serving GPRS Support Node (SGSN), which is in turn connected to a data network, a telephone switch, or both.

Each transmitting antenna on a tower requires a coaxial cable to be run from an equipment shelter at the base of the tower to the top of the tower. In practical situations, each operator on the tower may run six to twelve cables on the tower. These typically thick cables are required primarily to reduce signal attenuation. One result of placing the coaxial cables on the tower is that the tower has to withstand the additional weight. Thus, significant mechanical limitations have to be complied with regarding the load bearing capacity and wind withstanding capability of the communication towers. In some locations, regulations prescribe those limitations, which may require the operators to perform a structural analysis of the towers and often reinforce the towers or build new structures both of which may be costly.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to eliminating and/or reducing the need for coaxial cable traditionally found on cell towers by using optical fiber feed lines for non-traditional benefits. The cost of the fiber-optic feed lines and coaxial cables, as well as their performance for communication applications, are roughly similar. Fiber-optic feed lines are substantially lighter in weight and have greater bandwidth compared to coaxial cable feed lines. The use of fiber-optic feed lines reduces the wind load on the tower and allows the tower to be smaller in size and to be built at less cost. A smaller size tower also reduces the negative impact on the aesthetic appeal of the surrounding area.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 is a conceptual diagram illustrating aspects of communication tower design that have to be considered;

FIG. 2 illustrates an example communication tower with a plurality of coaxial cables used for signal transmission between circuitry/antennas on the tower and circuitry on the ground;

FIG. 3 illustrates an example communication tower according to embodiments, where individual coaxial cables are replaced by a single optical communication cable;

FIG. 4 illustrates example on-tower devices and on-ground devices for a system according to embodiments;

FIGS. 5A and 5B illustrate example on-tower devices and on-ground devices for a multi-level system according to embodiments;

FIG. 6 is a block diagram of an example on-ground communication system used in conjunction with a communication tower according to embodiments;

FIG. 7A illustrates a logic flow diagram for a process of receiving communication signals from an antenna on a communication tower according to embodiments and transmitting the signals to their destination; and

FIG. 7B illustrates a logic flow diagram for a process of receiving communication signals from on-ground sources at a communication tower according to embodiments and transmitting the signals to their destination through the antennas on the tower.

### DETAILED DESCRIPTION

As briefly discussed above, design aspects of wireless communication towers may be simplified and load-related problems reduced by using optical connection between on-ground electronics and on-tower electronics feeding the antennas. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

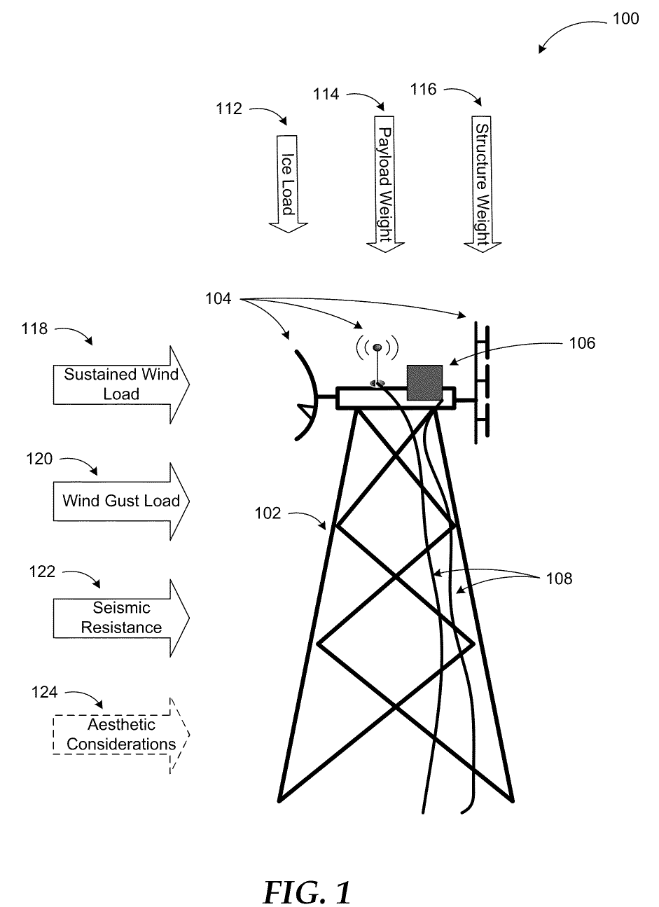

Referring to FIG. 1, conceptual diagram 100 of aspects for communication tower design that have to be considered is illustrated. With evolution and proliferation of wireless transmission technologies number and usage of communication towers are increasing as discussed above.

A typical communication tower may include a plurality of transmission equipment utilizing various frequency bands and transmission techniques. Some of those equipment (including antennas, electronic circuitry, mechanical support systems, and so on) may be shared or separate equipment may be used by individual service providers sharing the communication tower. Tower 102 is typically constructed of metal or similar strong materials (e.g. composite material). As mentioned, a number of antennas 104 of various types (e.g. dish antenna, omni-directional antenna, array antenna, etc.) may be installed on the communication tower. Some or all of the electronic circuitry 106 such as transmitters, receivers, amplifiers, modulators, demodulators, and so on may also be installed on the communication tower. Since wireless signals are subject to heavy losses during transmission over the air, the electronic circuitry may be preferably installed on the tower as close to the antenna(s) as possible. On the other hand, the circuitry may be installed in separate groups at various physical locations on the tower or nearby.

Where the circuitry is installed on the tower close to the antennas 104, one or more cables provide connection between the circuitry and on-ground devices. For example, a signal processing station may be connected to the on-tower electronics box through a series of cables that are laid underground and then onto the tower. In other cases, the electronic circuitry may be installed on-ground or in a different location and the signals provided to one or more antennas directly through a cable.

A communication tower like tower 102 is subject to various natural forces, which have to be taken into account when designing the tower mechanically and preparing tower layout (location, number, and position of the antennas and circuitry). Examples of such natural forces include, but are not limited to, sustained wind load 118, wind gust load 120, and ice load 112. Sustained wind load 118 is the expected horizontal push, the tower is likely to experience based on wind patterns in a geographical location. Wind gust load 120 is a similar force based on expected wind gusts in the same location. Wind gusts in some cases may exceed the sustained wind load significantly.

Most structural failures in towers occur due to the large diameter and large number of coaxial cables on the tower creating a “wall” of resistance against wind. A tower is anchored at the bottom and the wind hitting the coaxial cables acts like a lever. Commonly, there are about 12 cables per operator per technology (2 G, 3 G, etc.) and multiple operators co-locate on a tower (each of the cables are usually 1⅝ or ⅞ inch in diameter). This creates a significant “moment-arm” causing the tower to buckle under a strong wind condition. Many state or local governments have wind speed requirements on the towers that the operators/tower owners have to meet.

Other physical aspects of communication tower design include payload weight 114, structure weight 116, and seismic resistance 122. A tower, especially in a populated area needs to be safely designed. The structure itself presents a considerable amount of weight, which inherently works against safe design relating to the considerations discussed above. The weight of the equipment on the tower (antennas, electronic circuitry, etc.) adds to this complication. A final component in the design complication is the weight of cabling that needs to be run up the tower. In a typical communication tower, the number and weight of cables may raise as the number of antennas on the tower increases.

Furthermore, as higher frequencies are used in wireless communications, the loss of signal associated with those signals increases along with the frequency of the communication signal. Thus, larger diameter, lower loss cables may need to be used also increasing the weight of the cabling on the tower.

A sometimes optional consideration for communication towers, especially in urban areas, is aesthetics. Communication towers resembling large trees or hidden in other ways are becoming common. Large number or thick cables that have to be installed up a tower make it more difficult to design aesthetically pleasing communication towers.

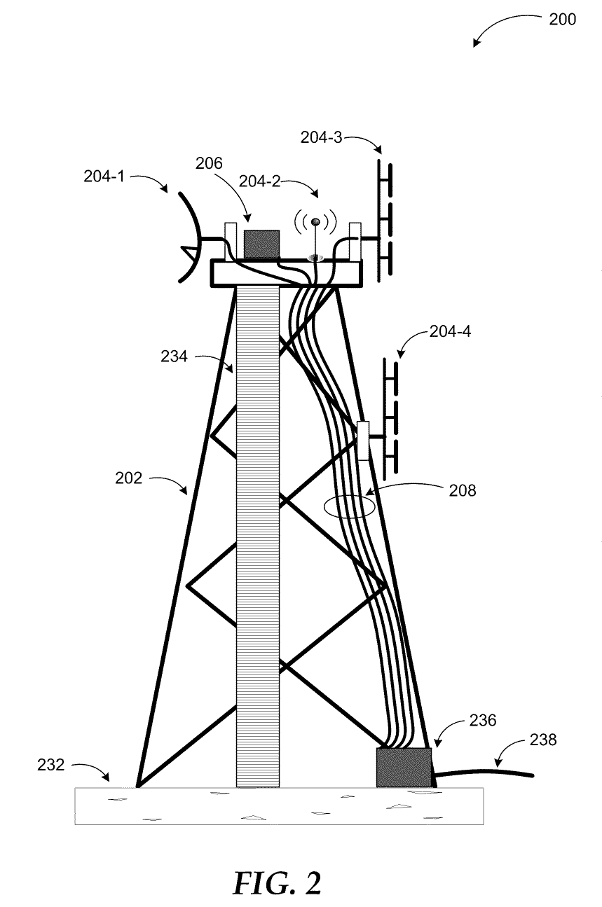

FIG. 2 illustrates an example communication tower with a plurality of coaxial cables used for signal transmission between circuitry/antennas on the tower and circuitry on the ground. Example communication tower 202 in diagram 200 is shown with two additional elements: a concrete base 232 and ladder 234 for servicing equipment on the tower. Other than these two elements, the structure of tower 202 may be similar to that of tower 102 in FIG. 1.

Another different aspect of communication tower illustrated in diagram 200 is antenna 204-4, which is installed about the middle of the communication tower 202. In other example towers, a number of antennas and associated electronic circuitry may be installed in various locations throughout the tower.

An on-ground electronics box 236 may contain circuitry and devices associated with processing signals. Box 236 may be coupled to other systems through cable 238. Box 236 may also be coupled through individual cables 208 to antennas 204-1 through 204-4. Box 236 may also be coupled to an on-tower electronics box 206, which may be used to feed some of the antennas and perform other tasks such as weather related measurements (e.g. temperature, wind speed). As mentioned above, some of the antennas may be coupled directly to box 236 for communication, while others may be associated with individual or group boxes located at various places on the tower. In either case, a number of potentially heavy cables may have to be installed up the communication tower.

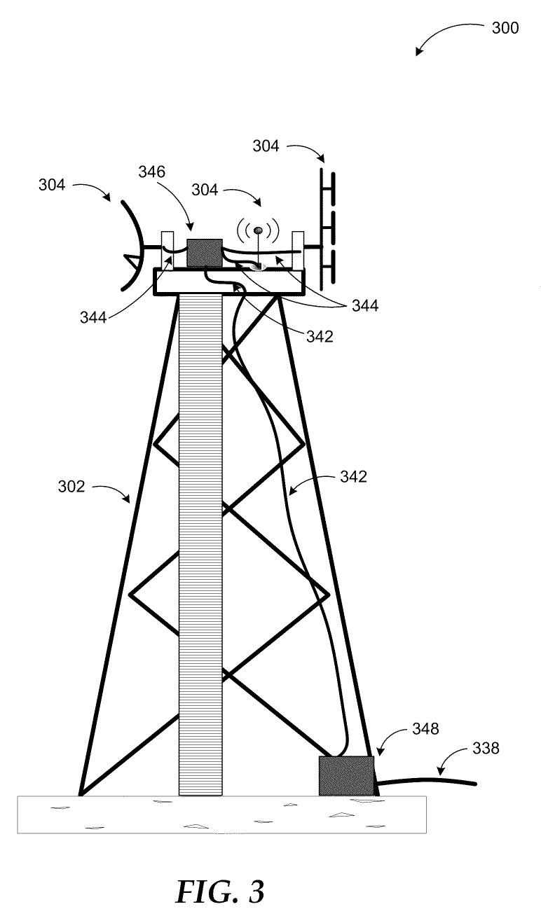

FIG. 3 illustrates an example communication tower according to embodiments, where individual coaxial cables are replaced by a single optical communication cable. Tower 302 in diagram 300 includes similar elements to the previously illustrated two communication towers with antennas 304 on top of the tower.

Differently from previous figures, on-ground electronics box 348 in diagram 300 is coupled to on-tower electronics box 346 through a single line as opposed to multiple antennas or electronics boxes using multiple cables. On-ground electronics box 348 is also coupled to other system(s) through cable 338. Antennas 304 are managed (bidirectional transmission and signal processing) by on-tower electronics box 346 through various shorter cables 344. Functionality associated with communications such as filtering, amplification, and other signal processing tasks may be located in one or both of the electronics boxes depending on the configuration.

Since use of a single metal-based (typically coaxial) cable for communication between the electronics boxes may not be practical or possible, a preferred embodiment utilizes optical communication between the boxes using a fiber-optic or similar cabling means. Cables used for optical communication such as fiber-optic cables have a considerably larger bandwidth accommodating communications through a much larger number of channels. Furthermore, the physical weight of such cables is significantly less compared to thick metal-based cables (e.g. copper) that are needed for broader bandwidth and smaller signal loss. The loss factor is, of course, also much smaller in optical communications compared to electrical signals.

Thus, by replacing multiple metal-based cables with a single fiber-optic cable on the tower, the weight factor for this component of the communication tower 302 can be significantly reduced aiding with the design aspects discussed in association with FIG. 1. Moreover, reliability factors of a communication tower according to embodiments are higher compared to a conventional one too. Use of a single fiber-optic cable compared to multiple metal-based ones decreases the likelihood of failure due to cable problems. Optical communications are inherently more reliable than electrical signals allowing utilization of more complicated error correction algorithms and digital communication protocols.

In a communication tower according to embodiments, an on-tower electronics box has to be utilized. However, in a basic implementation, the on-tower electronics box may be designed with minimally necessary circuitry including an optical-electrical conversion circuit. Payload weight increase due to the additional circuitry would be insignificant compared to the weight reduction due to the change in on-tower cable number and type.

Thus, some of the benefits of using fiber-optic feed lines in cell towers may be summarized as: (1) reduced weight on the tower to minimize modifications/reinforcements required to existing structures; (2) fewer number of towers since the towers today are limited by the weight they can handle and often not able to add additional operators; (3) lower cost of the structure for new constructions; (4) architects to design new forms of camouflaged tower structures; (5) minimize the need for equipment shelter at the tower location and associated need for HVAC and other equipment.

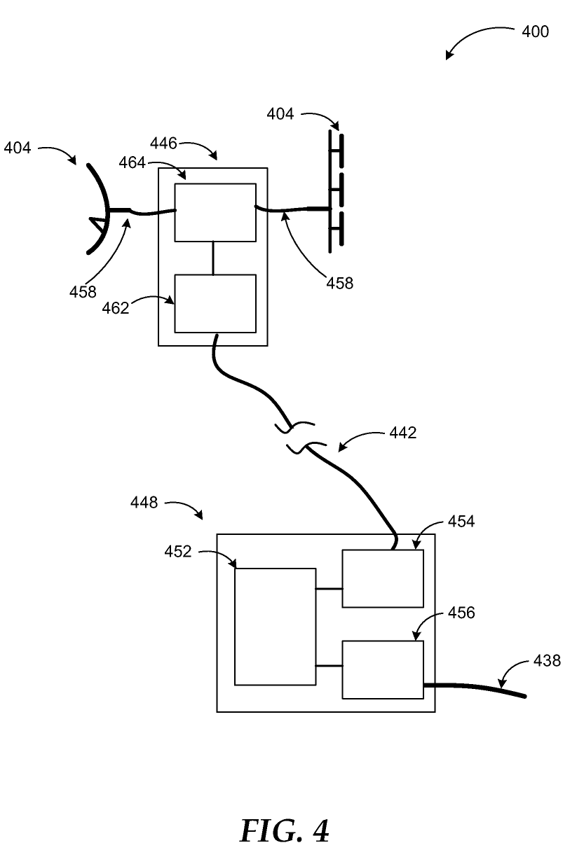

FIG. 4 illustrates example on-tower devices and on-ground devices for a system according to embodiments. In a basic system according to one embodiment, an on-ground electronics box 448 and an on-tower electronics box 446 form the main components of the communication tower along with antennas 404 as illustrated in diagram 400.

As discussed previously, antennas 404 may be any type of antenna. On-tower electronics box 446 includes any circuitry for providing antennas 404 with electrical signals through cables 458 to transmit over the air. On-tower electronics box 446 itself communicates with the on-ground electronics box 448 through optical cable 442.

In a basic configuration, on-tower electronics box 446 may include two components. Module 462 is to receive/transmit optical signals from/to the on-ground electronics box 448 and convert them to/from electrical signals. Module 464 is for processing electrical signals to and from the antennas. Processing may include a number of distinct operations such as filtering, amplification, digitization, D/A conversion, and similar operations. Some of those operations may also be performed in the on-ground electronics box 448.

On-ground electronics box 448 communicates with other components of the communication network through cable 438, which may be electrical or optical (or a combination of those). On-ground electronics box 448 may include, in a basic configuration, module 456 for receiving/transmitting electrical (in case of optical connection, optical signals) from/to the other components of the communication network. If optical signals are used, module 456 may also convert them to/from electrical signals for processing in the on-ground electronics box 448. Module 454 is for receiving/transmitting optical from/to the on-tower electronics box 446 and converting them to/from electrical signals. Module 452 is for performing any signal processing tasks including the above described ones and any others that may be necessary.

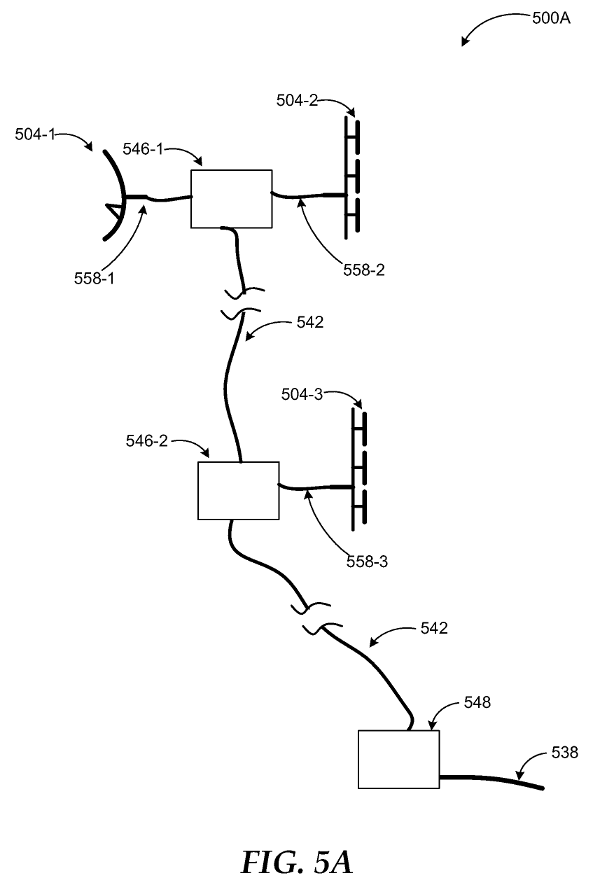

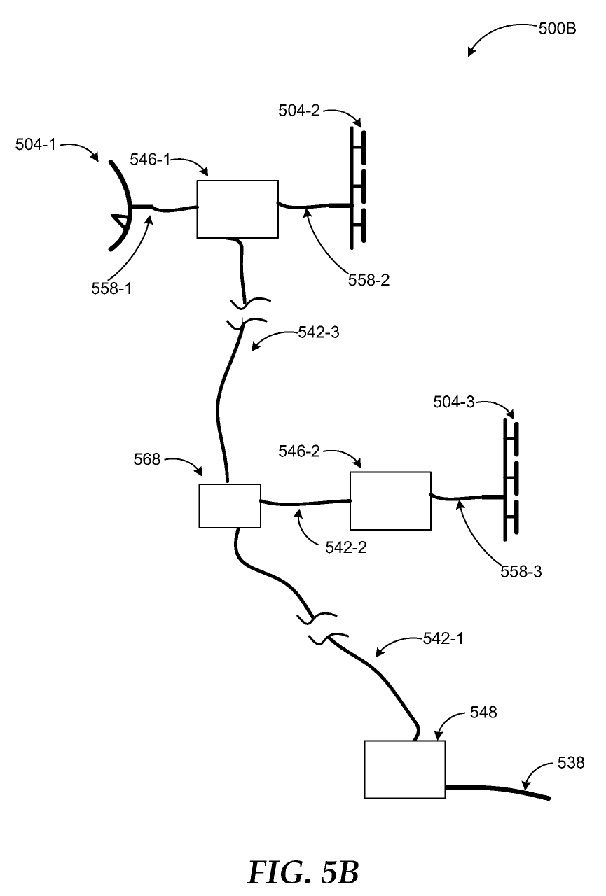

FIGS. 5A and 5B illustrate example on-tower devices and on-ground devices for a multi-level system according to embodiments. As discussed previously, antennas may be installed at different levels on a communication tower. For a number of reasons including, but not limited to, reduction of on-tower cabling and reduction of cabling losses, multiple on-tower electronics boxes 546-1 and 546-2 may be installed on the tower (e.g. one for each level) as shown in diagram 500A.

Thus, on-tower electronics box 546-1 may manage antenna 504-1 and 504-2 on the top level through cables 558-1 and 558-2. Similarly, antenna 504-3 may be managed by on-tower electronics box 546-2 through cable 558-3. Cables 558-1 through 558-3 are metal-based (coaxial) cables, but short in length, therefore not a significant addition to the total payload weight.

Both on-tower electronics boxes 546-1 and 546-2 are coupled to the on-ground electronics box 548 through optical cable 542. On-ground electronics box 548 communicates with other network components through ground cable 538.

Diagram 500B illustrates a similar multi-level communication tower with one difference. Instead of relaying the optical signal from the on-ground electronics box 548, on-tower electronics box 546-2 receives the optical signal from a signal splitter like on-tower electronics box 546-1.

Components in diagram 500B numbered similar to the components in diagram 500A are configured to operate in a likewise manner. Differently from the system of diagram 500A, optical cable 542-1 in the system of diagram 500B connects on-ground electronics box 548 with optical splitter 568. Optical splitter 568 splits the signals (or forwards appropriate signals) to the target on-tower electronics boxes through optical cables 542-2 and 542-3, which perform the operations discussed previously. Optical splitter 568 may perform additional tasks such as amplification, filtering, and redirection of received signals.

While the example systems and components in FIGS. 3, 4, 5A, and 5B have been described with specific parts, embodiments are not limited to these components, interactions between the components, or system configurations and may be implemented with other system configuration employing fewer or additional components. Functionality of a communication tower employing on-tower fiber-optic cabling may also be distributed among the components of the systems differently depending on component capabilities and system configurations.

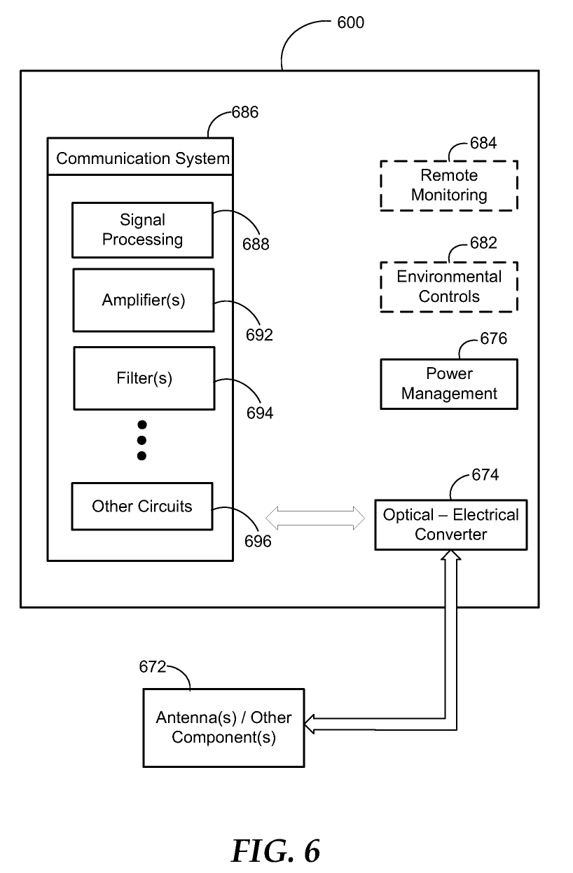

FIG. 6 and the associated discussion are intended to provide a brief, general description of a suitable computing environment in which embodiments may be implemented. With reference to FIG. 6, a block diagram of an example on-ground communication system used in conjunction with a communication tower according to embodiments. In a basic configuration, the on-ground communication system 600 may be an electronics box housing several components necessary for facilitating wireless communications through the communication tower in conjunction with other on-ground systems. On-ground communication system 600 may include a communication module 686 with signal processing module 688, amplification module 692, filtering module 694, and other circuits 696. Communication module 686 may, of course, include any circuitry necessary for processing signals received from other on-ground systems or signals from the on-tower electronics box.

On-ground communication system 600 may also include optional modules such as a remote monitoring module 684 for monitoring functionality of the communication tower (power, communication quality, etc.) and an environmental control module 682 for monitoring and/or controlling environmental conditions at the communication tower (e.g. heating or cooling of the electronics boxes). On-ground communication system 600 may also include a power management module 676 for managing power supply to some or all of the electrical circuitry on the tower.

An important module of the on-ground communication system 600 is optical-electrical signal converter module 674. In order to utilize a single fiber-optic cable on the tower instead of a plurality of coaxial cables, the signals (control and communication) from the on-ground communication system need to be converted to optical signals and the reverse needs to be performed for signals received from the on-tower electronics box. The on-tower electronics box managing communication with the antennas and other components on the communication tower is represented in the figure by the antenna(s)/other component(s) box 672.

On-ground communication system 600 may have additional features or functionality. Some of the additional devices and circuits installed in communication towers such as security devices are well known in the art and need not be discussed at length here.

Furthermore, some of the communication between the on-ground communication system and other components on the tower or on-ground may be facilitated through other means a wired network, a direct-wired connection, acoustic media, RF media, infrared media, and so on.

The claimed subject matter also includes methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

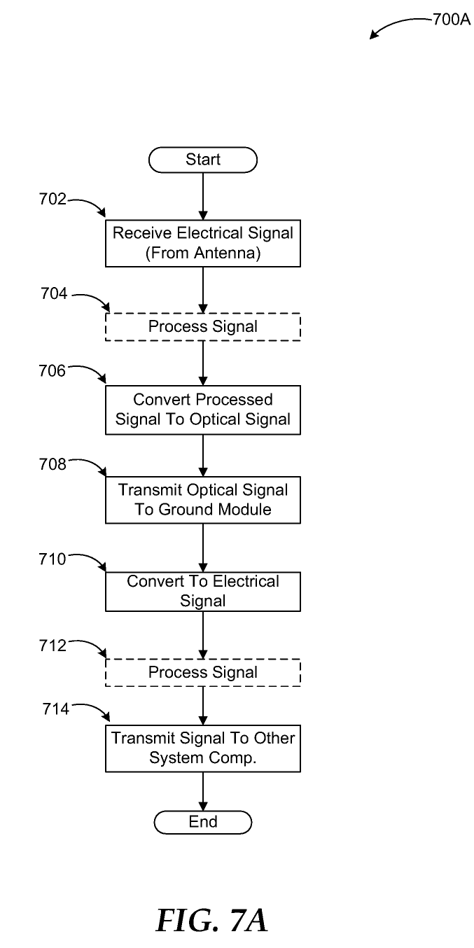

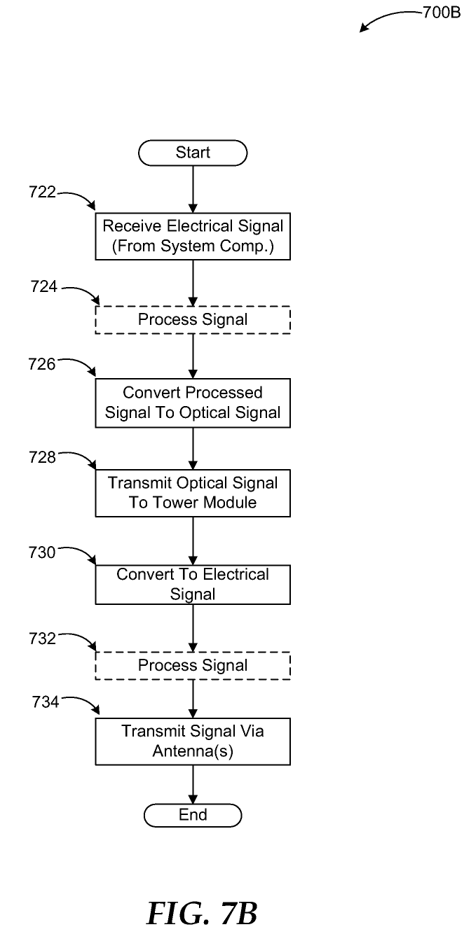

FIG. 7A illustrates a logic flow diagram for process 700A of receiving communication signals from an antenna on a communication tower according to embodiments and transmitting the signals to their destination according to embodiments. Process 700A may be implemented in an on-tower electronics box and an on-ground electronics box such as those illustrated in FIG. 3.

Process 700A begins with operation 702, where an electrical signal is received from an antenna. In the subsequent optional operation 704, the signal may be processed such as filtered, amplified, digitized, and so on. The optional signal processing is followed by operation 706, where the processed signal is converted to an optical signal.

The optical signal is transmitted to an on-ground electronics box at operation 708 through a fiber-optic cable installed on the tower. The optical signal is converted in the on-ground electronics box to an electrical signal at operation 710.

Subsequently, the electrical signal may be processed optionally in the on-ground electronics box (again filtering, amplification, and so on) at operation 712. Optional operation 712 is followed by operation 714, where the electrical signal is transmitted to other system components such as a central office, a network management system, and the like.

FIG. 7B illustrates a logic flow diagram for process 700B of receiving communication signals from on-ground sources at a communication tower according to embodiments and transmitting the signals to their destination through the antennas on the tower. Process 700B may also be implemented in the on-tower electronics box and the on-ground electronics box discussed above.

Process 700B begins with operation 722, where an electrical signal is received from a system component such as a central office, a network management system, and the like. In the subsequent optional operation 724, the signal may be processed such as filtered, amplified, digitized, and so on. The optional signal processing is followed by operation 726, where the processed signal is converted to an optical signal.

The optical signal is transmitted to the on-tower electronics box at operation 728 through a fiber-optic cable installed on the tower. The optical signal is converted in the on-tower electronics box to an electrical signal at operation 730.

Subsequently, the electrical signal may be processed optionally in the on-tower electronics box (again filtering, amplification, and so on) at operation 732. Optional operation 732 is followed by operation 734, where the electrical signal is transmitted via one of the antennas.

The operations included in processes 700A and 700B are for illustration purposes. Use of optical signals through a fiber-optic cable on a communication tower may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A communication system for facilitating wireless communications through a communication tower, the system comprising:
at least one wireless transmission antenna;
an on-ground electronics box coupled to a communication network, the on-ground electronics box configured to facilitate exchange of signals between the at least one antenna and the communication network; and
an on-tower electronics box coupled to the on-ground electronics box through an optical cable and to the at least one antenna through at least one electrical cable, the on-tower electronics box configured to facilitate exchange of signals between the at least one antenna and the on-ground electronics box through the optical cable.

2. The communication system of claim 1, wherein the on-tower electronics box includes at least one from a set of: a filtering module, an amplification module, an A/D conversion module, a D/A conversion module, a modulation module, and a demodulation module.

3. The communication system of claim 1, wherein the on-ground electronics box includes at least one from a set of: a filtering module, an amplification module, an A/D conversion module, a D/A conversion module, a modulation module, and a demodulation module.

4. The communication system of claim 1, wherein signal processing functionality is distributed between the on-ground electronics box and the on-tower electronics box according to a predefined configuration.

5. The communication system of claim 1, further comprising:
at least one other on-tower electronics box coupled to the on-ground electronics box through the optical cable, wherein the on-tower electronics box is dedicated to a first group of antennas on one level of the communication tower and the at least one other on-tower electronics box is dedicated to a second group of antennas on another level of the communication tower.

6. The communication system of claim 5, wherein the at least one other on-tower electronics box is located at a lower level compared to the on-tower electronics box, and is configured to relay optical signals between the on-tower electronics box and the on-ground electronics box.

7. The communication system of claim 5, further comprising:
an optical splitter module coupled to the on-ground electronics box, the on-tower electronics box, and the at least one other on-tower electronics box for facilitating optical communications between the three electronics boxes.

8. The communication system of claim 1, wherein at least one of the on-ground electronics box and the on-tower electronics box includes at least one from a set of: a weather monitoring module, a power monitoring module, and an operation monitoring module.

9. The communication system of claim 1, wherein the on-ground electronics box is coupled to the communication network through at least one of a wired connection and an optical connection.

10. The communication system of claim 1, wherein the at least one antenna includes a plurality of antennas each antenna being dedicated to one of: a particular frequency band and a particular transmission type.

11. The communication system of claim 1, wherein the communication tower includes a plurality of transmission equipment shared by a plurality of service providers.

12. The communication system of claim 1, further comprising mechanical support structure for the at least one antenna, the on-ground electronics box, the on-tower electronics box, and the optical and electrical cables.

13. A method of facilitating communications through a wireless communication tower, the method comprising:
receiving a first electrical signal from one of a plurality of antennas installed on the communication tower at a first on-tower electronics box;
converting the first electrical signal to a first optical signal;
transmitting the first optical signal through an optical cable installed on the communication tower to an on-ground electronics box;
converting the first optical signal to a second electrical signal;
transmitting the second electrical signal to a communication network;
receiving a third electrical signal from the communication network at the on-ground electronics box;
converting the third electrical signal to a second optical signal;
transmitting the second optical signal through the optical cable installed on the communication tower to the first on-tower electronics box;
converting the second optical signal to a fourth electrical signal; and
transmitting the fourth electrical signal to at least one of the plurality of antennas for wireless transmission.

14. The method of claim 13, further comprising:
processing at least one of the electrical signals in one of the first on-tower electronics box and the on-ground electronics box, wherein processing is performed by at least one from a set of: a filtering module, an amplification module, an A/D conversion module, a D/A conversion module, a modulation module, and a demodulation module.

15. The method of claim 13, further comprising:
receiving a fifth electrical signal from another one of the plurality of antennas installed on the communication tower at a second on-tower electronics box;
converting the fifth electrical signal to a third optical signal;
transmitting the third optical signal through the optical cable installed on the communication tower to the on-ground electronics box;
converting the third optical signal to a sixth electrical signal;
transmitting the sixth electrical signal to the communication network;
receiving a seventh electrical signal from the communication network at the on-ground electronics box;
converting the seventh electrical signal to a fourth optical signal;
transmitting the fourth optical signal through the optical cable installed on the communication tower to the second on-tower electronics box;
converting the fourth optical signal to an eighth electrical signal; and
transmitting the eighth electrical signal the other one of the plurality of antennas for wireless transmission.

16. The method of claim 15, wherein the first on-tower electronics box and the second on-tower electronics box are coupled to the on-ground electronics box through an optical splitter.

17. The method of claim 13, further comprising:
monitoring at least one of communications between the electronics boxes and environmental conditions at the communication tower; and
alerting a system administrator if a fault condition is detected.

18. A wireless communication tower comprising:
a plurality of wireless transmission antennas;
an on-ground electronics box coupled to a communication network through at least one of electrical and optical means;
a first on-tower electronics box coupled to the on-ground electronics box through an optical cable and to a first group of the plurality of antennas through electrical means, the first on-tower electronics box configured to facilitate exchange of signals between the first group of antennas and the on-ground electronics box through the optical cable;
a second on-tower electronics box coupled to the on-ground electronics box through the optical cable and to a second group of the plurality of antennas through electrical means, the second on-tower electronics box configured to facilitate exchange of signals between the second group of antennas and the on-ground electronics box through the optical cable; and
a mechanical support structure for the plurality of antennas, the on-ground electronics box, the first and second on-tower electronics boxes, and the optical cable.

19. The wireless communication tower of claim 18, wherein the first and second on-tower electronics boxes are further configured to process electrical signals received from and transmitted to the respective groups of antennas.

20. The wireless communication tower of claim 18, wherein the first and second on-tower electronics boxes and the on-ground electronics box are configured to exchange optical signals employing at least one from a set of frequency multiplexing, time-domain multiplexing, and phase multiplexing to accommodate a plurality of signals intended for individual antennas of the plurality of antennas.
